(19) United States
(12) Patent Application Publication
(10) Pub. No.: US 2016/0092620 A1
(43) Pub. Date: Mar. 31, 2016

(54) METHOD FOR POWER STATION SIMULATION FOR TEST AND TRAINING PURPOSES BY MEANS OF A PIECE OF DISTRIBUTED SIMULATION HARDWARE

(71) Applicant: Siemens Aktiengesellschaft, Munich (DE)

(72) Inventors: Dieter Kleyer, Herzogenaurach (DE); Torsten Olthoff, Uttenreuth (DE); Christian Spiska, Mohrendorf (DE)

(73) Assignee: Siemens Aktiengesellschaft, Munich (DE)

(21) Appl. No.: 14/861,081

(22) Filed: Sep. 22, 2015

(30) Foreign Application Priority Data
Sep. 29, 2014 (DE) 102014219709.0

(51) Int. Cl. G06F 17/50

(52) U.S. Cl. CPC G06F 17/5009

(57) ABSTRACT

A method for power station simulation, particularly for test purposes, by means of a piece of distributed simulation hardware that includes one or more emulation units, each having at least one emulation component, and also a simulation unit having a process model, where the method includes operating the emulation components cyclically with a common cycle time, using a respective cycle to form a time stamp, and automatically providing a data packet that is saved by each emulation component with the respective time stamp upon an appropriate command, wherein the data of the data packet are organized in accordance with a prescribed format and comprise a signal map.

### CROSS REFERENCE TO RELATED APPLICATIONS

This application claims the benefit of German Application No. DE 102014219709.0 filed 29 Sep. 2014, incorporated by reference herein in its entirety.

### FIELD OF INVENTION

The invention relates to a method for simulating a power station process and an automation solution (power station simulation) provided for the automation thereof by means of a piece of distributed simulation hardware, specifically—but not necessarily exclusively—a method for power station simulation for test purposes. The method is also suitable for training purposes, for example.

### BACKGROUND OF INVENTION

Exact recreation that corresponds to the particular temporal requirements of a power station process is the aim of any power station simulation. This aim can be achieved only by means of complex software functions that in turn require powerful computers. Typically, these functions, which contain firstly the process-engineering simulation of the power station process and secondly the emulation of the control-engineering installation/hardware, are executed on a (single) computer. Both functions (simulation and emulation) are closely coupled and interchange data with one another inside a single computer of this kind. Simulation, emulation, data interchange and coupling are each proprietary in this case. Each power station simulation is therefore unique at the present time. This also results, inter alia, from the respectively used operating systems and/or the programming languages used changing from project to project on the basis of the providers of the process-engineering simulation.

The software that is required for emulating the control-engineering installation in the case of a power station simulation needs to be matched to the simulation of the power station process on a project-specific basis in each case. This relates not only to the respectively used operating system but also to the interchange of the data and the integration into the software functions of the process-engineering simulation, that is to say the recreation of the respective physical process using a process model. This close coupling has considerable disadvantages for the producer of the control-engineering emulation.

### SUMMARY OF INVENTION

It is therefore an object of the present invention to propose a method for power station simulation that is based on a control-engineering emulation that is independent of the specific properties of the respective simulation. An emulation that uses standardized data interchange to communicate with the process-engineering simulations of the process model producers and is independent of the various operating systems meets this objective.

The aforementioned object is accordingly achieved with a simulation method having the features of the independent claim. In this case, a method for power station simulation that is intended particularly for test purposes has provision for the following: the power station simulation is effected by means of a piece of distributed simulation-emulation hardware—subsequently referred to as simulation hardware or simulation system for short in summary—that comprises at least one emulation unit and also at least one simulation unit, that is to say a computer or the like. The respective process model is instantiated on the at least one simulation unit. At least one emulation component is instantiated on the or each emulation unit. When the method is executed, each emulation component emulates a device, for example an automation system in the form of a programmable logic controller (PLC), or a function of the control-engineering installation. Each emulation component is executed cyclically with a cycle time that is common to all the emulation components and with a common time base. A respective cycle is automatically used by the respective emulation component to form a value for a time stamp. The time stamp encodes a piece of time information. By way of example, such a piece of time information is an instantaneous value of a counter that is incremented or decremented with each new cycle. A data packet that is saved by each emulation component upon an appropriate command in the course of simulation operation is automatically provided with the respective time stamp, and the data that the data packet comprises are organized in accordance with a prescribed format and comprise a signal map, namely the sum total of all the data generated by the process model for the respective emulation component, and also the sum total of all the data that are output to the process model by the respective emulation component. In this case, the signal map comprises analog and/or digital data, with a digital equivalent of the respective datum being stored in the case of analog data.

The advantage of the invention is firstly the use of a piece of distributed simulation hardware, the individual hardware units, that is to say at least the first and second emulation units and also the at least one simulation unit with the process model, being communicatively connected to one another, and interchanging data via the respective communicative connection, in a manner that is fundamentally known per se. The hitherto rigid coupling of simulation (process model) and emulation (control-engineering installation; automation hardware) is therefore offset and a producer of a control-engineering emulation can concentrate on the respective emulation units and in so doing stipulate the respectively used computer hardware in the short term too, so that continuous matching to development progress in the hardware realm is possible. In addition, the emulation can involve the use of operating systems and programming languages/environments that do not necessarily need to be identical to the operating systems or programming languages/environments that are provided for executing the process model. This decoupling therefore allows an option for continuous matching to development progress in the software realm.

The distributed simulation hardware also allows the execution of the power station simulation under comparatively rigid time constraints, namely a cycle time of 100 ms, for example. A power station simulation needs to run in real time and with a sufficiently short cycle time. This cycle time must be observed both by the process model and by the emulation. Only when this is the case is it actually possible to ensure consistency between the data packets stored by the individual emulation components upon a specific command. Since each stored data packet is provided with a time stamp automatically generated by the respective emulation component and is stored together with this time stamp, it is possible for an affiliation between individual data packets to be ascertained automatically. On the basis of such automatically ascertainable affiliation between the stored data packets, namely between the data packets stored by the emulation components that the simulation system comprises, it is possible to a certain extent to restore a frozen state of the simulation at a later instant on a cycle-precise basis (consistently). For that, the time stamp is used to automatically ascertain affiliated data packets, and the data that these comprise are again supplied to the respective emulation component and to the process model.

The complexity of power station installations today means that the necessary result is corresponding complexity for the simulation system. One aspect of the complexity in this case is simply the pure number of devices in the automation hardware that are also mapped in the simulation system. In similar fashion to the real hardware or the projected hardware (original system), the emulation recreates the devices and units—for example programmable logic controllers, local field devices and the like—that the original system comprises, namely in the form of a respective emulation component. In this case, the emulation of the automation level uses the automation software produced by an engineering system in unaltered form and edits it within the context of the recreated automation level. Each emulation component thus executes the automation software that is provided for its real or projected counterpart. This involves the performance, in a similar fashion to the original system, of cyclic editing of the automation software within the simulation system by the respective emulation component, which acts as what is known as a soft PLC for this purpose, for example, that is to say comprises at least one software functionality in the form of an interpreter (PLC interpreter), said software functionality being intended and set up to convert program code instructions of a PLC program into programming code instructions that can be executed by the respective target hardware of the emulation component and the microprocessor therein. In this case, the program editing is performed either in a fundamental cycle or in a multiple of the fundamental cycle in accordance with the project planning.

In order to preserve a state of the simulation system for the purpose of later restoration of this state, capture and retrievable storage of the data that are relevant thereto are required. In principle, the identification of characteristic states of a system and hence also of a simulation system requires considerable effort and above all it is necessary to perform individual identification of the respective states for each system. The approach proposed here therefore takes a different path and provision is made for a respective signal map to be stored. Each signal map comprises the sum total of all the data generated by the process model for the respective emulation component and also the sum total of all the data that need to be output or are output to the process model by the respective emulation component. Since each emulation component is supplied with the data intended for it from the respective signal map and the process model is supplied with the data from the signal maps of the emulation components, a signal state specified by the sum total of the signal maps (system state) is restored.

Since the preservation and the later recall of a system state requires a not insignificant volume of data to be stored, namely the system map of each emulation component on a cycle-precise basis, provision is furthermore made for each data packet comprising a respective system map to comprise only the actual useful data, that is to say only the data that are output to the respective emulation component by the process model and only the data from the emulation component that are provided for the process model. Optionally, the system map may comprise further useful data. In this case, the format/layout of a data packet is specific to the respective emulation component, since each emulation component processes and produces respectively individual data. Such a layout for a data packet from an emulation component is constant during the simulation, however. For this reason, it is possible—for example on the basis of project planning data for the engineering system—to use a constant layout for each data packet, with the respective layout for each datum specifically specifying the position of said datum within the data packet and the data type thereof. When a data packet is loaded, the same layout is used, so that the previously stored data are available again within the simulation.

The reduction of the data to be stored, namely the data of the signal map, to the pure useful data allows cycle-precise preservation of a state of the simulation and hence later restoration of such a state. The storage is effected as a reaction to an appropriate signal, that is to say a command from a control station, for example. In this case, it should be borne in mind that, on the basis of a usual number of automation systems to be emulated (several dozen devices in a given case 200 devices or more) and a corresponding number of emulation components and also a usual number of signals to be processed (usually several thousand signals, in a given case 25 000 signals or more), a considerable volume of data results that needs to be managed on a cycle-precise basis. Only the reduction in the data to be stored to the pure useful data allows this for the demanded cycle times of 100 ms, for example.

Advantageous embodiments of the simulation method are the subject matter of the subclaims. Back-references used therein indicate the further development of the subject matter of the main claim by the features of the respective subclaim. They are not intended to be understood as dispensing with the attainment of independent, substantive protection for the combinations of features in the dependent subclaims. Furthermore, in respect of interpretation of the claims for more detailed specification of a feature in a subordinate claim, it can be assumed that such limitation is not present in the respective preceding claims.

In one embodiment of the method, restoring a past state of the power station simulation involves automatically using the time stamp to ascertain associated data packets and supplying the data that said data packets comprise to the respective emulation components and also to the process model. Since the data that the data packets comprise represent a partial state of the simulation system, namely to the extent of the influence of the respective emulation component on the overall state, at the instant of the recording, that is to say at the instant at which the data packet is stored, restoration of all affiliated data packets results in restoration of the state of the whole simulation system at the instant at which the individual data packets are recorded. Temporal consistency is ensured in this case, because only affiliated data packets are used to restore a past system state. The affiliation is obtained in this case on the basis of the time stamp that each data packet comprises.

Should the situation arise that it is not possible to ascertain a data packet with fitting time stamp for at least one emulation component, restoration of the system state is not possible and a corresponding error message is automatically produced and output to inform the user. In that case, the user can attempt to restore a system state associated with a different instant. A particular embodiment of the method involves automatic monitoring of which system states can be reproduced automatically, that is to say concerning those time stamp values for which a fitting data packet is actually available for each emulation component, and only these system states are offered to the user for selection.

In a further or alternative embodiment of the method, a respective format of a data packet stored by an emulation component automatically results on the basis of an interpretation of project planning data from a respectively emulated original system. In this manner, a format that is constant at least for the duration of the simulation is obtained for all the data packets, each emulation component producing a data packet in a format that is specific to the emulation component. On account of the automatic obtainment of the respective format by way of automatic interpretation of the project planning data, the respective format does not need to be prescribed in an elaborate manner and in a way that is also known to be decidedly error-prone as part of manual programming.

In yet a further or alternative embodiment of the method, the emulation units and the emulation components have an associated communication component that uses association data to automatically prompt firstly forwarding of data generated by the process model to precisely that emulation component for which the data are intended and in so doing secondly also selects that emulation unit on which the respective emulation component runs. On the basis of such association and forwarding of the data generated by the process model, there is resultant optimization of the volume of data to be transmitted within the simulation system. In fact, only precisely those data that require transmission are transmitted, whereas without such association and forwarding it would alternatively be necessary to forward all the data generated by the process model to all the emulation components.

In an advantageous addition to this embodiment of the method, the association data (likewise) result on the basis of all automatic interpretation of project planning data from a respectively simulated original system. On account of the automatic obtainment of the association data by way of automatic interpretation of the project planning data, the association data do not need to be prescribed in an elaborate manner and in a way that is also known to be decidedly error-prone as part of manual programming.

The aforementioned object is also achieved with a distributed simulation system for power station simulation that operates according to the method as described here and below and to this end comprises means for performing the method. In this case, the invention is implemented in software. The invention is therefore firstly also a computer program having program code instructions that can be executed by a computer and secondly a storage medium having a computer program of this kind, that is to say a computer program product having program code means, and also finally firstly also a computer or the like that is combined with other identical or similar devices in a network and into whose memory such a computer program has been loaded or can be loaded as means for performing the method and the embodiments thereof, and secondly the computer network as a whole that acts as a simulation system.

An exemplary embodiment of the invention is explained in more detail below with reference to the drawing. Items or elements that correspond to one another are provided with the same reference symbols in all the figures.

The exemplary embodiment is not intended to be understood as a restriction of the invention. Rather, the present disclosure by all means also allows additions and modifications, particularly such additions and modifications as, for example through combination or modification of individual features or method steps that are described in conjunction with the general or specific part of the description and are contained in the claims and/or the drawing, are evident to a person skilled in the art for achieving the object and, through combinable features, result in a new item or in new method steps or series of method steps.

### BRIEF DESCRIPTION OF THE DRAWINGS

In the figures,

FIG. 1 shows a simulation system with a piece of distributed simulation hardware, and

FIG. 2 shows a data packet, produced by an emulation component running on the simulation hardware as a signal map, for preserving and possibly later restoring a state of the simulation system or of a subsystem within the simulation system that is defined by the signal map.

### DETAILED DESCRIPTION OF INVENTION

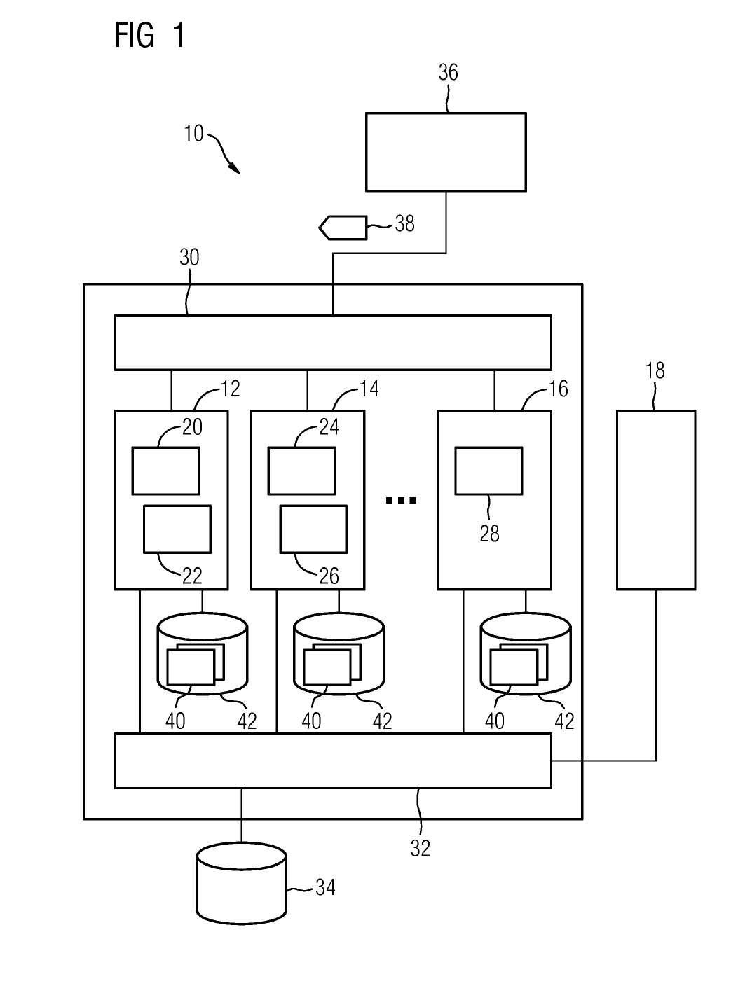

The illustration in FIG. 1 shows a schematically simplified form of a simulation system 10 intended for power station simulation. Said simulation system comprises, in the form of a piece of distributed simulation hardware, at least one emulation unit 12, 14, in this case a first and a second emulation unit 12, 14, and possibly further emulation units 16. The or each emulation unit 12-16 is a separate device, for example a computer. The simulation system 10 furthermore includes at least one device on which a process model 18 is instantiated for the purpose of simulating the respective power station process. At least one emulation component 20, 22, 24, 26, 28 is instantiated on the or each emulation unit 12-16, and each emulation component 20-28 represents a device in the original system, that is to say the respective real automation hardware or the projected automation hardware. The emulation units 12-16 and the emulation component 20-28 loaded thereon firstly have an associated control and synchronization mechanism 30, subsequently referred to as synchronization mechanism 30 for short, and secondly an associated communication component 32. In this case, the simulation system 10 can comprise a synchronization mechanism 30 that is common to all the emulation units 12-16 and also a communication component 32 that is common to all the emulation units 12-16 or a plurality of such functional units respectively associated with an emulation unit 12-16. The communication component 32 is used to ensure the connection to the process model 18, so that data generated by the process model 18 that pertain to the individual emulation units 12-16 and to the respective emulation components 20-28 and vice versa can reach the process model 18 from the emulation components 20-28. For this purpose, the communication component 32 comprises association data 34 or has access to such association data 34, which reveal which datum produced by the process model 18—for example a datum representing a cooling water temperature—is intended for which emulation component 20-28 or which emulation components 20-28. Furthermore, the association data 34 include a piece of information concerning the emulation unit 12-16 onto which an emulation component 20-28 identified as the recipient of a respective datum has been loaded.

In order to preserve a state of the simulation, a “SaveSnapshot” command, which reaches all the emulation components 20-28 simultaneously or at least sufficiently simultaneously by means of the control/synchronization mechanism 30, and which is subsequently referred to just as command 38 for short, is initiated on a control station (instruction station) 36, for example, which is associated with the simulation system 10 and communicatively connected thereto in a suitable manner that is known per se. On reception of this command 38, in the course of simulation operation, each emulation component 20-28 stores a data packet 40 that is representative or semirepresentative of the state of the simulation. As suitable storage location for these data packets 40 is the main memory of the respective emulation unit 12-16 or a mass memory 42, that is to say hard disk or the like, for example, that the respective emulation unit 12-16 comprises or that is associated therewith. In this case, individual emulation units 12-16 can access one and the same mass memory 42 together. Such a mass memory 42 is also suitable as a storage location for the association data 34. The method therefore allows cycle-precise production of such data packets 40, which in turn represent what are known as initial conditions (ICs) for the simulation.

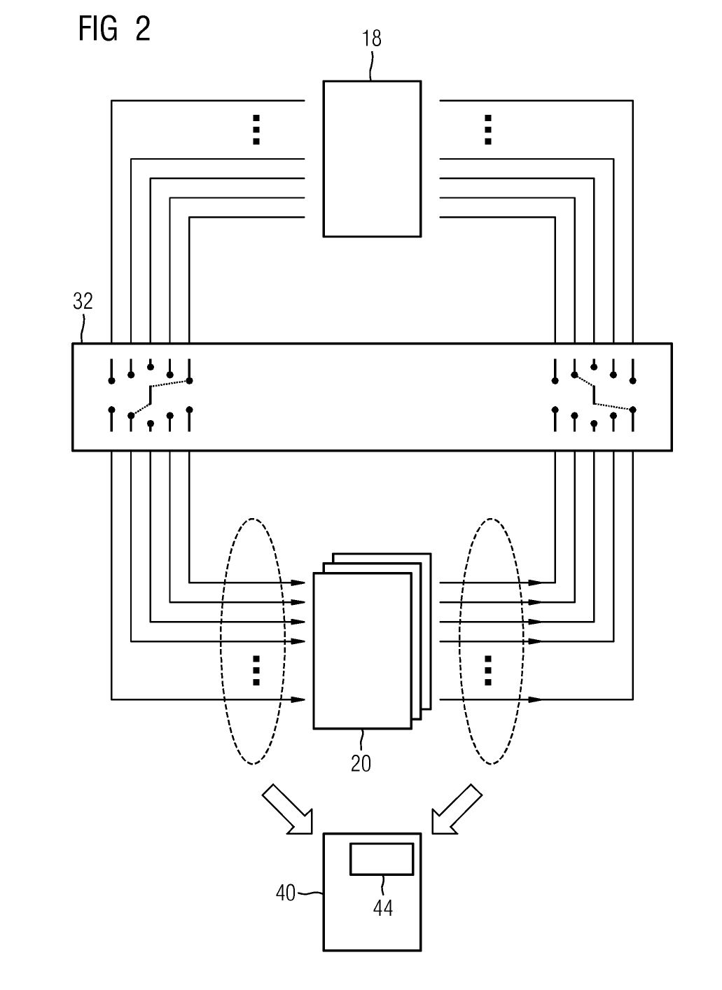

The illustration in FIG. 2 is intended to illustrate the aspect of the signal map and the data packet 40 stored on the basis thereof in connection with the reception of a command 38 by each emulation component 20-28. Each emulation component 20-28 interacts at least with the process model 18. In this case, the emulation component 20-28 receives signals (left-hand side of the illustration in FIG. 2) generated by the process model 18 for the respective emulation component 20-28. These signals correspond to those signals that are picked up in a real power station process by means of an appropriate sensor system in the power station process, that is to say, by way of example, a signal that encodes a temperature measured value picked up by means of a temperature sensor. On the basis of such signals, and on the basis of the automation software executed by the emulation component 20-28, the emulation component 20-28 generates signals that are output to the process model 18 (right-hand side of the illustration in FIG. 2). These signals correspond to those signals that, in the case of a real power station process, are output to individual actuators of the actuator system that the power station process comprises. Examples are a signal that represents a control command for opening or closing a valve, or a signal that represents a nominal value preset for speed regulation for a drive.

When storing a data packet 40, the respective signals (analog or digital signals) are taken as a basis for generating appropriate data, for example a one-byte datum for representing a digital signal or a digital signal together with an associated variable, for example a flashing rate, and a four-byte datum for representing an analog signal. This is clarified in the illustration in FIG. 2 by the two block arrows pointing to the data packet 40.

The data are organized within the data packet 40 in accordance with the prescribed format/layout. This is evident from the project planning data of the engineering system, for example. There it is specified, in a manner that is known per se, which data are processed by which device or which devices as part of the automation solution and which data type forms the basis of the respective datum. The result for the simulation is thus that the project planning data directly reveal, by way of example, on what portion of the original system (and hence of the corresponding emulation component 20-28) a datum representing a temperature measured value, for example, is processed and that this datum is a representation of an analog measured value. The sum of this information reveals specifically which data are processed by each emulation component 20-28 and on which data type each datum is based. This determines the format/layout of the data packet 40, which is constant during the simulation but can also be automatically regenerated at any time in the event of a change in the automation software. On receiving an appropriate command 38, each emulation component 20-28 stores a respective data packet 40 in this format/layout. When the data packet 40 is later loaded, the data that it comprises are interpreted in accordance with the format/layout taken as the basis for the storage.

The data packets 40 stored in order to preserve a state of the power station simulation are also referred to as initial conditions (IC) for short, since the later consistent loading of affiliated data packets 40, that is to say the restoration of the initial conditions that are obtained by means of the data that the data packets 40 comprise, allows just these previously captured initial conditions to be used to continue the power station simulation (again), specifically if need be also multiple times in succession, for example if, on the basis of the same initial conditions in each case, different scenarios are meant to be tested or taught. In this case, the different scenarios may be different operator control actions and/or different operations in the power station process following the state determined by the initial conditions.

Furthermore, the illustration in FIG. 2—likewise just schematically in highly simplified form—again shows the communication component 32 that uses the association data 34 (FIG. 1) to undertake association—more precisely association and forwarding—of the signals that are output by the process model 18 with/to the respective emulation component 20-28 and of the data that are output by an emulation component 20-28 with/to the process model 18. In simplified terms, a suitable conceptual model for the association and forwarding functionality of the communication component 32 is a multiplexer whose “switching position” is obtained on the basis of the respectively incoming signal and of a destination for the respective signal that is encoded in the association data 34, namely firstly of the emulation component 20-28 for which the signal is intended and secondly of the emulation unit 12-16 on which the receptive emulation component 20-28 is instantiated.

Finally, the illustration in FIG. 2 also shows that each data packet 40 stored by an emulation component 20-28 has a time stamp 44 that is generated automatically in connection with the storage of the emulation component 20-28. The time stamp 44 encodes an explicit piece of information for that cycle in which the data packet 40 was stored and the data that said data packet comprises and also the underlying signals were valid. For automatic formation of the time stamp 44, the evaluation of a counter running concomitantly in each emulation component 20-28 comes into question, said counter being incremented or decremented for each new cycle. Since all the emulation components 20-28 operate cyclically with a common cycle time and a common time base, the time stamp 44 can be used to automatically identify an affiliation between individual data packets 40 at any time even when there are a multiplicity of stored data packets 40, since all those data packets 40 that each have an identical time stamp 44 are affiliated.

Such storage of data packets 40 and the possibility of recalling the data packets 40 and the content thereof at a later instant makes the method for power station simulation suitable for test purposes and training purposes. A particular state of the simulation can be frozen and hence preserved, as it were, by sending the command 38, for example. This state can be consistently restored at any time by loading the affiliated data packets 40 and, on the basis of such a state that can be restored at any time, different scenarios can be acted out for the execution of the respective power station process.

A time stamp 44 or a signature that corresponds to a time stamp in terms of function is also used for the transfer of the data that are output to the process model 18 by the respective emulation component 20-28 and/or of the data that are generated for the emulation components 20-28 by the process model 18. The process model 18 evaluates this signature in order to apply temporally affiliated signals from the emulation components 20-28 in temporally consistent fashion (in sync) in the process model 18. By way of example, a suitable signature is the value of a counter that is incremented or decremented with each cycle. It is then possible for the process model 18 to identify a temporal and above all cycle-precise affiliation between the respective data received from individual emulation components 20-28. A software functionality that is installed on each emulation unit 14-16 and the or each simulation unit 18, for example as part of the communication component 32, acts as a synchronization mechanism for the distributed simulation system 10 in this case. By way of example, such a synchronization mechanism can monitor whether the respectively expected data arrives within a prescribed period of time from all the units communicating with one another within the simulation system 10, namely the emulation components 20-28 on the one hand and the process model 18 on the other. In this case, the duration of the prescribed period of time corresponds to the respective cycle time. During a cycle, the process model 18, for example, thus expects data having an identical signature from all the emulation components 20-28. If no data or no data having the expected signature arrive from at least one emulation component 20-28, there is a real time infringement that is signaled to the user. The synchronization mechanism thus ensures cycle-precise operation of the simulation and emulation components 20-28.

Although the invention has been illustrated and described in more detail by means of the exemplary embodiment, the invention is not restricted by the disclosed example(s) and other variations can be derived therefrom by a person skilled in the art without departing from the scope of protection of the invention.

Individual foreground aspects of the description submitted here can therefore be briefly summarized as follows: the specification relates to a method for power station simulation, particularly for test and training purposes, by means of a piece of distributed simulation hardware that comprises at least two emulation units 12-16, having at least one emulation component 20-28 running on each emulation unit 12-16, and also a simulation unit having a process model 18, wherein the emulation components 20-28 operate cyclically with a common cycle time of 100 ms, for example, and a common time base, wherein a respective cycle is used to form a value for a time stamp 44 and a data packet 40 that is saved by each emulation component 20-28 upon an appropriate command 38 is automatically provided with the respective time stamp 44 and wherein the data that the data packet 40 comprises are organized in accordance with a prescribed format and comprise a signal map, namely the sum of all the data generated by the process model 18 for the respective emulation component 20-28 and also of the data that are output to the process model 18 by the respective emulation component 20-28.

### LIST OF REFERENCE SYMBOLS

10 Simulation system

12 Emulation unit

14 Emulation unit

16 Emulation unit

18 Process model

20 Emulation component

22 Emulation component

24 Emulation component

26 Emulation component

28 Emulation component

30 Control and synchronization mechanism

32 Communication component

34 Association data

36 Control station

38 Command

40 Data packet

42 Mass memory

44 Time stamp

1. A method for power station simulation for test purposes by means of a piece of distributed simulation hardware that comprises at least one emulation unit, having at least one emulation component running on the or each emulation unit, and also at least one simulation unit having a process model, the method comprising:
operating the emulation components cyclically with a common cycle time and a common time base,
using a respective cycle to form a value for a time stamp and automatically providing a data packet that is saved by each emulation component upon an appropriate command with the respective time stamp,
organizing the data of the data packet in accordance with a prescribed format and to comprise a signal map, namely the sum of all the data generated by the process model for the respective emulation component and also of the data that are output to the process model by the respective emulation component.

2. The method as claimed in claim 1, further comprising:
restoring a past state of the power station simulation by automatically using the time stamp to ascertain associated data packets and supplying the data of said data packets to the respective emulation component and also to the process model.

3. The method as claimed in claim 1, further comprising:
performing automatic monitoring concerning those time stamp values for which a data packet with a corresponding time stamp is available for each emulation component, and only offering restoration of the or each system state defined thereby.

4. The method as claimed in claim 1,
wherein a respective format of a data packet stored by an emulation component automatically results on the basis of an interpretation of project planning data from a respectively simulated original system.

5. The method as claimed in claim 1, further comprising
using association data by an associated communication component of the emulation units and the emulation components to automatically prompt forwarding of data generated by the process model to that emulation component for which the data are intended and to select that emulation unit on which the respective emulation component runs.

6. The method as claimed in claim 5,
wherein the association data automatically result on the basis of an interpretation of project planning data from a respectively simulated original system.

7. The method as claimed in claim 1, further comprising
providing the data generated by the process model for the respective emulation component and/or the data that are output to the process model by an emulation component with a signature in the form of a counter that is incremented or decremented with each cycle, wherein data expected during a cycle are checked for temporal affiliation using the signature and wherein the absence of data expected during a cycle prompts a real time infringement to be signaled.

8. A computer program residing on a non-transitory computer readable media comprising
program code means adapted to perform the method of claim 1 when the computer program is executed for the purpose of simulating a power station process.

9. A non-transitory digital storage medium comprising
electronically readable control signals that can interact with a computer that is adapted for simulating a power station process such that the method as claimed in claim 1 is executed.
